(19) United States
(12) Patent Application Publication
(10) Pub. No.: US 2008/0016047 A1
(43) Pub. Date: Jan. 17, 2008

(54) SYSTEM AND METHOD FOR CREATING AND POPULATING DYNAMIC, JUST IN TIME, DATABASE TABLES

(76) Inventors: Richard D. Dettinger, Rochester, MN (US); Frederick A. Kulack, Rochester, MN (US); Erik E. Voldal, Rochester, MN (US); Eric W. Will, Oronoco, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/456,902

(22) Filed: Jul. 12, 2006

(51) Int. Cl. G06F 17/30

(52) U.S. Cl. 707/4

(57) ABSTRACT

A method, system and article of manufacture for executing database queries where the data being queried resides in both relational databases and other external data sources, and, more particularly, for creating a dynamic, just in time, database table using data retrieved from an external source. One embodiment provides a method of processing a database query. The method includes receiving, from a requesting entity, an abstract query of data contained in a database and an external data source, the abstract query being defined using logical fields of a data abstraction model abstractly describing the data in the database and the external data source. The method further includes generating, from the abstract query, an executable query capable of being executed by a query engine, wherein the executable query includes a reference to a temporary data structure, generating the temporary data structure using data retrieved from the external data source, and executing the executable query against the database and the temporary data structure to obtain a result set.

### CROSS-RELATED APPLICATION

This application is related to the following commonly owned application: U.S. patent application Ser. No. 10/083,075, filed Feb. 26, 2002, entitled “APPLICATION PORTABILITY AND EXTENSIBILITY THROUGH DATABASE SCHEMA AND QUERY ABSTRACTION,” which is hereby incorporated herein in its entirety.

### BACKGROUND OF THE INVENTION

1. Field of the Invention

The present invention generally relates to processing database queries and, more particularly, to techniques for processing a database query using data from both a relational database and other data sources.

2. Description of the Related Art

Databases are computerized information storage and retrieval systems. A relational database management system is a computer database management system (DBMS) that uses relational techniques for storing and retrieving data. The most prevalent type of database is the relational database, a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Regardless of the particular architecture, a DBMS can be structured to support a variety of different types of operations. Such operations can be configured to retrieve, add, modify and delete information being stored and managed by the DBMS. Standard database access methods support these operations using high-level query languages, such as the Structured Query Language (SQL). The term “query” denominates a set of commands that cause execution of operations for processing data from a stored database. For instance, SQL supports four types of query operations, i.e., SELECT, INSERT, UPDATE and DELETE. A SELECT operation retrieves data from a database, an INSERT operation adds new data to a database, an UPDATE operation modifies data in a database and a DELETE operation removes data from a database.

Any requesting entity, including applications, operating systems and users, can issue queries against data in a database. Queries may be predefined (i.e., hard coded as part of an application) or may be generated in response to input (e.g., user input). Upon execution of a query against a database, a result set is returned to the requesting entity.

However, data may often be available from sources other than a relational database. For instance, assume a user desires to search for information about patients in a hospital, such as name, nickname, age, gender and address. Assume further that an underlying database includes database tables that have name, age, gender, and address columns, but that the database does not include nickname information. Because the query references data not in an underlying database table (specifically, the patient nickname), the query cannot be run against this database. Assume now that the nickname information can be retrieved from an external data source, such as a text file. In this case, to execute such a database query, the nickname information needs to be retrieved from the text file and included with the database. This approach requires that the user is authorized and able to perform any required changes to the underlying database. Alternatively, a user could manually compare query results with information from the nickname file. In practice, however, this approach is likely to become both time consuming and error prone.

Therefore, there is a need for an efficient technique for integrating data from external data sources with data from databases and for managing database query execution where the data being queried resides in both relational databases and other external data sources.

### SUMMARY OF THE INVENTION

The present invention is generally directed to a method, system and article of manufacture for executing database queries where the data being queried resides in both relational databases and other external data sources, and, more particularly, for creating a dynamic, just in time, database table using data retrieved from an external source. One embodiment of the invention includes a method of processing a database query. The method generally includes receiving, from a requesting entity, an abstract query of data contained in a database and an external data source, the abstract query being defined using logical fields of a data abstraction model abstractly describing the data in the database and the external data source. The method generally further includes generating, from the abstract query, an executable query capable of being executed by a query engine, wherein the executable query includes a reference to a temporary data structure, generating the temporary data structure using data retrieved from the external data source, and executing the executable query against the database and the temporary data structure to obtain a result set.

Another embodiment of the invention includes a computer-readable medium containing a program which, when executed by a processor, performs operations for processing a database query. The operations generally includes receiving, from a requesting entity, an abstract query of data contained in a database and an external data source, the abstract query being defined using logical fields of a data abstraction model abstractly describing the data in the database and the external data source. The operations further includes generating, from the abstract query, an executable query capable of being executed by a query engine, wherein the executable query includes a reference to a temporary data structure, generating the temporary data structure using data retrieved from the external data source, and executing the executable query against the database and the temporary data structure to obtain a result set.

Still another embodiment includes a computing device having at least one processor and a memory containing a program for optimizing a database query, which, when executed, performs an operation for processing a database query. The operation generally includes receiving, from a requesting entity, an abstract query of data contained in a database and an external data source, the abstract query being defined using logical fields of a data abstraction model abstractly describing the data in the database and the external data source. The operation further includes generating, from the abstract query, an executable query capable of being executed by a query engine, wherein the executable query includes a reference to a temporary data structure, generating the temporary data structure using data retrieved from the external data source, and executing the executable query against the database and the temporary data structure to obtain a result set.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates a computer system that may be used in accordance with the invention;

FIG. 2 is a relational view of software components used to create and execute database queries, according to one embodiment of the invention;

FIGS. 3A-3B are relational views of software components illustrating an abstract query model environment according to one embodiment of the invention;

FIGS. 4-5 are flow charts illustrating the operation of a runtime component, according to one embodiment of the invention;

FIG. 6 is a flow chart illustrating a method for executing a query, according to one embodiment of the invention; and

FIGS. 7-8 are flow charts illustrating the operation of an exemplary software component used to create and populate a dynamic, just in time, database table, according to one embodiment of the invention.

### DETAILED DESCRIPTION OF THE PREFERRED EMBODIMENTS

### Introduction

The present invention is generally directed to a method, system and article of manufacture for executing database queries where the data being queried resides in both relational databases and other external data sources, and, more particularly, for creating a dynamic, just in time, database table using data retrieved from an external source. For example, a dynamic, just in time, may be generated using data retrieved from a text file or from results returned from a search engine query. Typically, a database query specifies conditions used to evaluate whether a given element of data should be included in a result set and at least one result field specifying what data elements should be returned in the result set.

In one embodiment, an underlying database(s) may be accessed using one or more data abstraction models abstractly describing physical data in the underlying database(s). Such a data abstraction model may also provide users with access to data stored in external data sources. Thus, using a data abstraction model, abstract queries against the physical data can be constructed regardless of the structure or representation used by an underlying physical database and/or an external data structure. The data abstraction model may include a runtime component configured to generate an executable query from the abstract query in a form consistent with a physical representation of the data.

In one embodiment, a dynamic, just in time table may be created whenever an abstract query is submitted that references data in the external data source. A dynamic, just in time table may be populated with data from the external data source and linked to the underlying database. For execution, the abstract query is transformed into an executable query, (e.g., an SQL statement) that includes references to a dynamic, just in time tables. As described in greater detail herein, a dynamic, just-in-time table may be generated using data from an external data source. The data abstraction model handles the aspects of retrieving data from the external source, storing data in the dynamic, just in time table, and joining the data from the external source with other tables in an underlying database.

### PREFERRED EMBODIMENTS

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

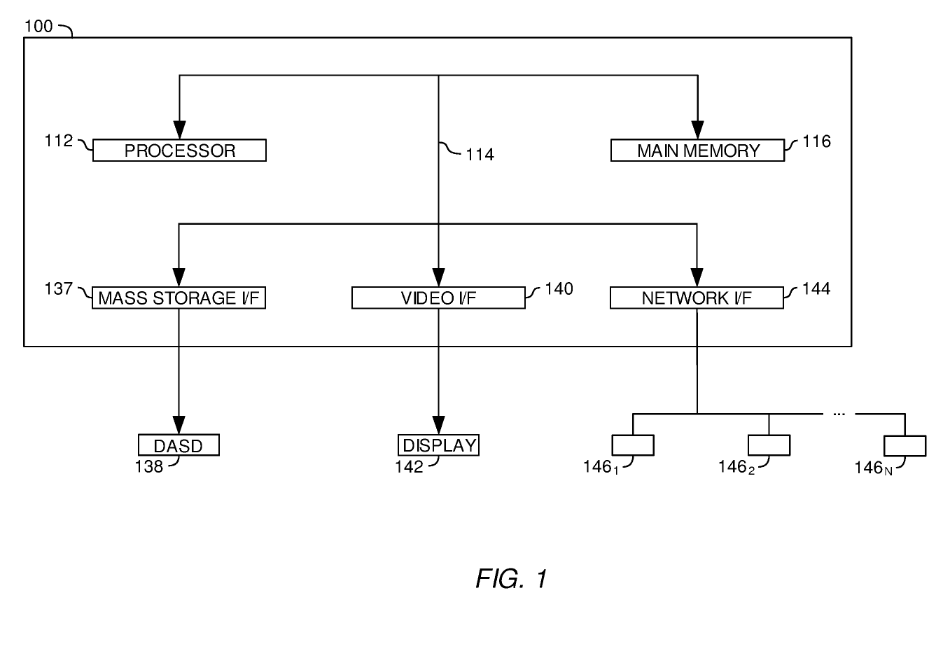

One embodiment of the invention is implemented as a program product for use with a computer system such as, for example, computer system 110 shown in FIG. 1 and described below. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD- or DVD-ROM disks readable by a CD- or DVD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information to/from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

### An Exemplary Computing Environment

FIG. 1 illustrates a simplified view of a computer 100 (part of a computing environment 110). The computer 100 may represent any type of computer, computer system or other programmable electronic device, including a client computer, a server computer, a portable computer, a personal digital assistant (PDA), an embedded controller, a PC-based server, a minicomputer, a midrange computer, a mainframe computer, and other computers adapted to support the methods, apparatus, and article of manufacture of the invention. The invention, however, is not limited to any particular computing system, device or platform and may be adapted to take advantage of new computing systems and devices as they become available.

Illustratively, the computer 100 is part of a networked system 110. In this regard, the invention may be practiced in a distributed computing environment in which tasks are performed by remote processing devices that are linked through a communications network. In a distributed computing environment, program modules may be located in both local and remote memory storage devices. In another embodiment, the computer 100 is a standalone device. For purposes of construing the claims, the term “computer” shall mean any computerized device having at least one processor. The computer may be a standalone device or part of a network in which case the computer may be coupled by communication means (e.g., a local area network or a wide area network) to another device (i.e., another computer).

In any case, it is understood that FIG. 1 is merely one configuration for a computer system. Embodiments of the invention can apply to any comparable configuration, regardless of whether the computer 100 is a complicated multi-user apparatus, a single-user workstation or a network appliance that does not have non-volatile storage of its own.

The computer 100 could include a number of operators and peripheral systems as shown, for example, by a mass storage interface 137 operably connected to a storage device 138, by a video interface 140 operably connected to a display 142, and by a network interface 144 operably connected to the plurality of networked devices 146 (which may be representative of the Internet) via a suitable network. Although storage 138 is shown as a single unit, it could be any combination of fixed and/or removable storage devices, such as fixed disc drives, floppy disc drives, tape drives, removable memory cards or optical storage. The display 142 may be any video output device for outputting viewable information.

Computer 100 is shown comprising at least one processor 112, which obtains instructions and data via a bus 114 from a main memory 116. The processor 112 could be any processor adapted to support the methods of the invention. In particular, the computer processor 112 is selected to support the features of the present invention. Illustratively, the processor is a PowerPC® processor available from International Business Machines Corporation of Armonk, N.Y.

The main memory 116 is any memory sufficiently large to hold the necessary programs and data structures. Main memory 116 could be one or a combination of memory devices, including Random Access Memory, nonvolatile or backup memory, (e.g., programmable or Flash memories, read-only memories, etc.). In addition, memory 116 may be considered to include memory physically located elsewhere in the computer system 110, for example, any storage capacity used as virtual memory or stored on a mass storage device (e.g., direct access storage device 138) or on another computer coupled to the computer 100 via bus 114. Thus, main memory 116 and storage device 138 could be part of one virtual address space spanning multiple primary and secondary storage devices.

### An Exemplary Database and Query Environment

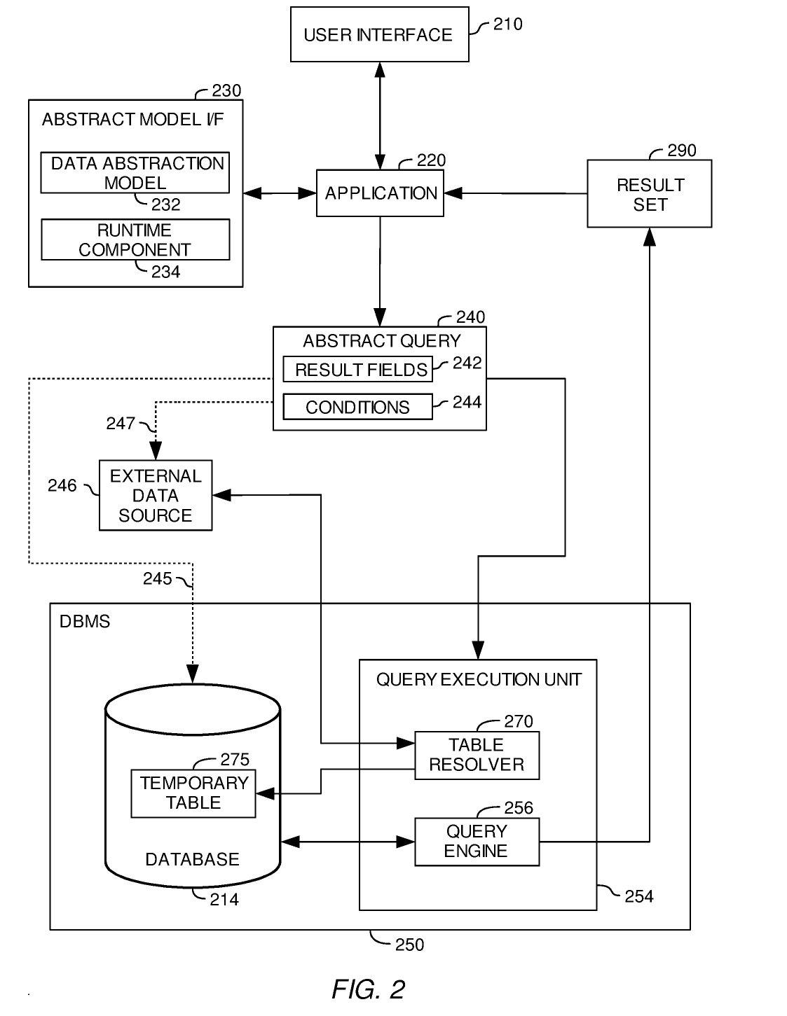

FIG. 2 illustrates a relational view of software components, according to one embodiment of the invention. The software components illustratively include a user interface 210, a DBMS 250, one or more external data sources 246 (only one data source is illustrated for simplicity), one or more applications 220 (only one application is illustrated for simplicity) and an abstract model interface 230. The abstract model interface 230 illustratively provides an interface to a data abstraction model 232 and a runtime component 234. The DBMS 250 illustratively includes a database 214 and a query execution unit 254 having a query engine 256 and an instance of a table resolver object 270.

According to one aspect, the application 220 (and more generally, any requesting entity) submits queries evaluated using data from database 214 and external data source 246. The database 214 is shown as a single database for simplicity. However, a given query can be executed against multiple databases which can be distributed relative to one another. Moreover, one or more databases can be distributed to one or more networked devices (e.g., networked devices 146 of FIG. 1). The database 214 is representative of any collection of data regardless of the particular physical representation of the data. A physical representation of data defines an organizational schema of the data. By way of illustration, the database 214 may be organized according to a relational schema (accessible by SQL queries) or according to an XML schema (accessible by XML queries). However, the invention is not limited to a particular schema and contemplates extension to schemas presently unknown. As used herein, the term “schema” refers to a particular arrangement of data.

In one embodiment, the external data source 246 contains data that is related to, but not included with the database 214. By way of example, the external data source 246 may be a text file that contains data with a relationship to data in the database 214. For instance, assume that the database 214 contains data about patients in a hospital, such as name, age, gender and address information arranged in tables having name, age, gender and address columns. Assume further that the external data source 246 is a text file that contains a list of patient-name and nicknames for some patients with data in database 214. In other words, the nickname information included with the external data source 246 is related to the patient data included with the database 214, but not included therewith.

In one embodiment, data in the external data source 246 is defined by metadata associated with the data in the database 214. Furthermore, the data in the external data source 246 can be defined by metadata associated with external data such as documents that are referenced by URLs, for example. However, the type of the data and whether or not the data in the external data source 246 relates to the data in the database 214 is not limiting of the invention. Instead, various types of data included with the external data source 246 are broadly contemplated. For instance, assume that the external data source 246 is associated with the data in the database 214 only by means of an issued query. For example, the external data source 246 may have data related to specialists in different medical domains arranged by the geographic area where a given specialist practices. In this case, the issued query can request data for patients living in a given city and having a particular disease, as well as for a specialist practicing in the area of residence of such patients. Thus, the information about the specialists is linked to the patient information only via the issued query. All such implementations are broadly contemplated.

The queries issued by the application 220 may be predefined (i.e., hard coded as part of the application 220) or may be generated in response to input (e.g., user input). In one embodiment, the queries issued by the application 220 can be created by users using the user interface 210, which can be any suitable user interface configured to create/submit queries. According to one aspect, the user interface 210 is a graphical user interface. Note, however, the user interface 210 is shown by way of example; any suitable requesting entity may create and submit queries against the database 214 (e.g., the application 220, an operating system or an end user). Accordingly, all such implementations are broadly contemplated.

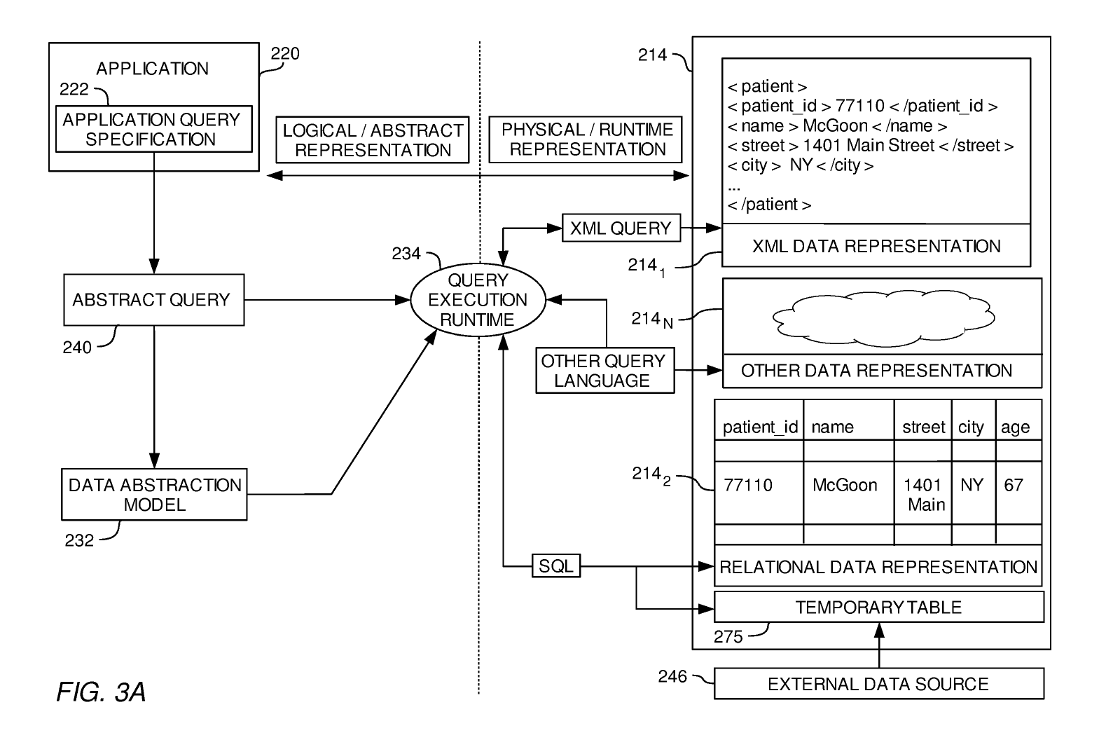

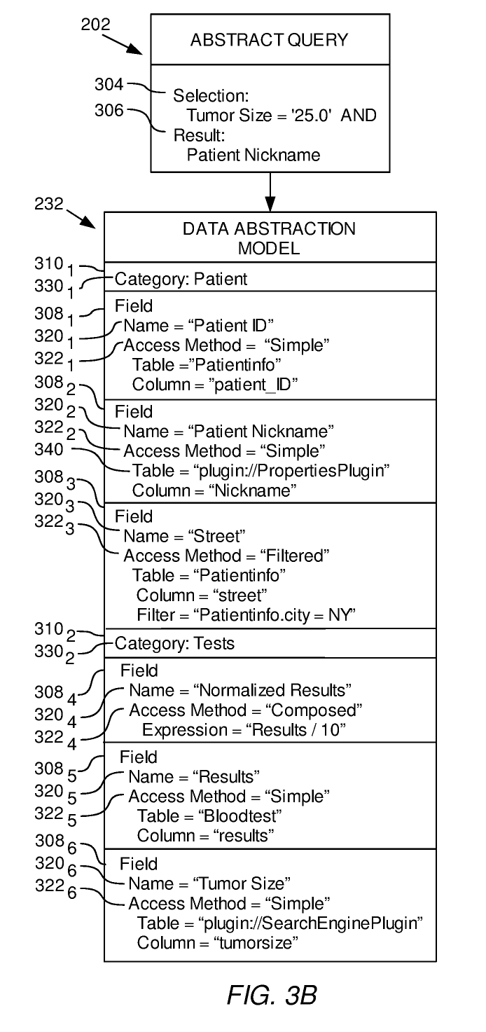

In one embodiment, the queries issued by the application 220 are composed using the abstract model interface 230. In other words, the queries are composed from logical fields provided by the data abstraction model 232 and translated by the runtime component 234 into a concrete (i.e., executable) query for execution. Such queries are referred to herein as “abstract queries.” An exemplary abstract model interface is described below with reference to FIGS. 3A-5.

Illustratively, the application 220 issues an abstract query 240 that requests data from the database 214, as illustrated by a dashed arrow 245, and data from the external data source 246, as illustrated by a dashed arrow 247. For instance, assume that the abstract query 240 requests name, age, gender and address information from the database 214 and nickname information from the external data source 246, as was noted above. To this end, the abstract query 240 includes result fields 242 for which data from the database 214 and the external data source 246 is to be returned in a corresponding result set 290 to the application 220, such as name, age, gender, address and nickname. Note, however, from the user's perspective, the user simply includes the desired fields in the query, either as result fields or as part of a query condition. The name, age, gender, address and nickname fields correspond to logical fields defined by the data abstraction model 232. The abstract query 240 illustratively further includes one or more query conditions 244 for specifying which data contained in the database 214 and/or the external data source 246 should be returned for each one of the result fields 242. However, it should be noted that the conditions 244 are merely illustrated by way of example. In other words, abstract queries without conditions are contemplated.

As noted above, according to one aspect, the user may interact with user interface 210 to compose abstract query 240. To this end, the user interface 210 may display a suitable graphical user interface (GUI) screen for composing abstract query 240. For instance, a GUI screen can be configured to display a plurality of user-selectable elements, each representing a logical field of the data abstraction model 232 that may be selected to include in the set of result fields 242. For example, a variety of different GUI screen displays could show the “patient id”, “name”, “age”, “gender”, “diagnosis”, “address” and “nickname” fields as user-selectable elements that may be included in an abstract query.

Note, in one embodiment, the data abstraction model 232 includes logical fields referring to data in the database 214 and/or data in the external data source 246, as described in more detail below with reference to FIG. 3B. As described above, in the given example nickname information is not included with the database 214, but with the external data source 246, while all other information is included with the database 214. However, the nickname field is included with the data abstraction model 232 together with other fields relating to data included with the database 214, such as the “name”, “age”, “gender,” and “address” fields.

The GUI screen displayed in the user interface 210 may also display graphical elements allowing users to specify a query condition 244 using a logical field of the data abstraction model 232. However, using a GUI to specify the abstract query 240 is merely described by way of example and not meant to be limiting of the invention. In other words, any possible technique for composing abstract query 240 is broadly contemplated.

In one embodiment, the runtime component 234 generates an executable query from the abstract query. Further, the runtime component 234 may be configured to generate an executable query that includes a reference to a temporary table 275 in the database 214. The temporary table may be populated with data from the external data source 246. The size of the temporary table 275 can be minimized by filtering the data from the external data source 246 prior to populating the temporary table. In one embodiment, the filtering is performed using a data request 280 generated by the query execution unit 254, on the basis of the executable query (as illustrated by a dashed arrow 282). An exemplary embodiment of the operations of the runtime component 234 for generating the executable query and the data request 280, and for generating a temporary table 275 using data from the external data source 275 is described in greater detail below.

The executable query is submitted to the query execution unit 254 for execution against database 214. Query execution unit 254 identifies the reference to the temporary table 275 in the executable query and generates data request 280. Then, query execution unit 254 creates an appropriate instance of table resolver object 270, which may be configured to retrieve data from the external data source 246 and generate the temporary table 275. More generally, a given table resolver object 270 may implement methods for (1) initializing an instance of the table resolver object, (2) generating a temporary table, and (3) removing or cleaning-up the temporary table 275 once it is no longer needed (i.e., after a query has been executed). By way of example, an initialization method may be configured to determine whether the external data source 246 exists and, if so, whether a database or network connection is required to access the external data source 246. If so, the initialization method can further be configured to establish the required database or network connection. The specific actions required to initialize a table resolver object 270 (if any) will typically depend on the particular implementation. Generally however, the initialization method allows a table resolver object 270 to perform any actions that need to be performed only once for an instance of that table resolver object.

A table generation method may be invoked to generate the temporary table 275 and link the temporary table with data in the database 214. A removal method may be invoked to remove the temporary table 275 after query execution. In one embodiment, the generation method may be further configured to generate a reference that may be used by identify a particular temporary table; such a reference may be passed between components of the query executing unit 254.

The query execution unit 254 uses the query engine 256 to execute the executable query against the database 214. Including queries that retrieve data from a dynamic, just in time table generated according to an embodiment of the invention. As shown, the query execution unit 254 includes only the query engine 256 for query execution, for simplicity. However, the query execution unit 254 may include other components, such as a query parser and a query optimizer. A query parser is generally configured to accept a received query input from a requesting entity, such as the application(s) 220, and then parse the received query. The query parser may then forward the parsed query to the query optimizer for optimization. A query optimizer is an application program which is configured to construct a near optimal search strategy (known as an “access plan”) for a given set of search parameters, according to known characteristics of an underlying database (e.g., the database 214), an underlying system on which the search strategy will be executed (e.g., computer system 110 of FIG. 1), and/or optional user specified optimization goals. In general, such search strategies determine an optimized use of available hardware/software components to execute a query. Once an access plan is selected, the query engine 256 then executes the query according to the access plan.

When executing the executable query against the database 214 having the temporary table 275, the query engine 256 identifies each data record of the database 214 and, thus, the temporary table 275 that satisfies the abstract query 240. Each identified data record is included with the result set 290. The result set 290 is then returned to the application(s) 220.

In one embodiment, when the result set 290 is returned to the application(s) 220, the temporary table 275 is removed from the database 214. Alternatively, the temporary table 275 is removed from the database 214 when the application(s) 220 is terminated. In other words, the temporary table 275 is dynamically generated in and removed from the database 214 and, therefore, also referred to as “dynamic table” hereinafter. However, other implementations are possible. For instance, the temporary table 275 can be stored persistently as part of the database 214. Accordingly, all such implementations are broadly contemplated.

### Logical/Runtime View of Environment

FIGS. 3A-3B show an illustrative relational view of software components, according to one embodiment of the invention. According to one aspect, the software components are configured for managing query execution. Illustratively, the software components include application 220, data abstraction model 232, runtime component 234, database 214 and external data source 246 of FIG. 2. As shown, the database 214 includes a plurality of exemplary physical data representations 214₁, 214₂, . . . 214_{N} and the temporary table 275.

As noted above with reference to FIG. 2, the application 220 issues the abstract query 240 against the database 214 and the external data source 246. In one embodiment, the application 220 issues the query 240 as defined by a corresponding application query specification 222. In other words, the abstract query 240 is composed according to logical fields rather than by direct reference to underlying physical data entities in the database 214 and/or the external data source 246. The logical fields are defined by the data abstraction model 232 which generally exposes information as a set of logical fields that may be used within a query (e.g., the abstract query 240) issued by the application 220 to specify criteria for data selection and specify the form of result data returned from a query operation. Furthermore, the abstract query 240 may include a reference to an underlying model entity that specifies the focus for the abstract query 240. In one embodiment, the application query specification 222 may include both criteria used for data selection (selection criteria 304; e.g., conditions 244 of FIG. 2) and an explicit specification of the fields to be returned (return data specification 306; e.g., result fields 242 of FIG. 2) based on the selection criteria 304, as illustrated in FIG. 3B.

The logical fields of the data abstraction model 232 are defined independently of the underlying data representation (i.e., one of the plurality of exemplary physical data representations 214_{1-N}) being used in the database 214 and/or the external data source 246, thereby allowing queries to be formed that are loosely coupled to the underlying data representation. More specifically, a logical field defines an abstract view of data whether as an individual data item or a data structure in the form of, for example, a database table. As a result, abstract queries such as the query 240 may be defined that are independent of the particular underlying data representation used. Such abstract queries can be transformed into a form consistent with the underlying physical data representation 214_{1-N} for execution against the database 214. By way of example, the abstract query 240 is translated by the runtime component 234 into an executable query which is executed against the database 214 to determine a corresponding result set (e.g., result set 290 of FIG. 2) for the abstract query 240.

In one embodiment, illustrated in FIG. 3B, the data abstraction model 232 comprises a plurality of field specifications 308₁, 308₂, 308₃, 308₄, 308₅ and 308₆ (six shown by way of example), collectively referred to as the field specifications 308 (also referred to hereinafter as “field definitions”). Specifically, a field specification is provided for each logical field available for composition of an abstract query. Each field specification may contain one or more attributes. Illustratively, the field specifications 308 include a logical field name attribute 320₁, 320₂, 320₃, 320₄, 320₅, 320₆ (collectively, field name 320) and an associated access method attribute 322₁, 322₂, 322₃, 322₄, 322₅, 322₅ (collectively, access methods 322). Each attribute may have a value. For example, logical field name attribute 320₁ has the value “Patient ID” and access method attribute 322₁ has the value “Simple.” Furthermore, each attribute may include one or more associated abstract properties. Each abstract property describes a characteristic of a data structure and has an associated value. In the context of the invention, a data structure refers to a part of the underlying physical representation that is defined by one or more physical entities of the data corresponding to the logical field. In particular, an abstract property may represent data location metadata abstractly describing a location of a physical data entity corresponding to the data structure, like a name of a database table or a name of a column in a database table. Illustratively, the access method attribute 322₁ includes data location metadata “Table” and “Column.” Furthermore, data location metadata “Table” has the value “Patientinfo” and data location metadata “Column” has the value “patient_ID.” Accordingly, assuming an underlying relational database schema in the present example, the values of data location metadata “Table” and “Column” point to a table “Patientinfo” having a column “patient_ID.”

In one embodiment, groups (i.e. two or more) of logical fields may be part of categories. Accordingly, the data abstraction model 232 includes a plurality of category specifications 310₁ and 310₂ (two shown by way of example), collectively referred to as the category specifications. In one embodiment, a category specification is provided for each logical grouping of two or more logical fields. For example, logical fields 308₁₋₃ and 308₄₋₆ are part of the category specifications 310₁ and 310₂, respectively. A category specification is also referred to herein simply as a “category.” The categories are distinguished according to a category name, e.g., category names 330₁ and 330₂ (collectively, category name(s) 330). In the present illustration, the logical fields 308₁₋₃ are part of the “Patient” category and logical fields 308₄₋₆ are part of the “Tests” category.

The access methods 322 generally associate (i.e., map) the logical field names to data in the database (e.g., database 214 of FIG. 2) or data in the external data source (e.g., external data source 246 of FIG. 2). As illustrated in FIG. 3A, the access methods associate the logical field names either to a particular physical data representation 214_{1-N} in the database or to a particular external data source. By way of illustration, two data representations are shown in the database 214, an XML data representation 214₁ and a relational data representation 2142. However, the physical data representation 214_{N} indicates that any other data representation, known or unknown, is contemplated. In one embodiment, a single data abstraction model 232 contains field specifications (with associated access methods) for two or more physical data representations 214_{1-N}. In an alternative embodiment, a different single data abstraction model 232 is provided for each separate physical data representation 214_{1-N}.

Any number of access methods is contemplated depending upon the number of different types of logical fields to be supported. In one embodiment, access methods for simple fields, filtered fields and composed fields are provided. The field specifications 308₁, 308₂, 308₅ and 308₆ exemplify simple field access methods 322₁, 322₂, 322₅, and 322₆, respectively. The field specification 308₃ exemplifies a filtered field access method 322₃. The field specification 308₄ exemplifies a composed field access method 322₄.

Simple fields can be mapped directly to a particular entity in the underlying physical representation (e.g., a field mapped to a given database table and column) of the database 214. By way of illustration, as described above, the simple field access method 322₁ shown in FIG. 3B maps the logical field name 320₁ (“Patient ID”) to a column named “patient_ID” in a table named “Patientinfo”.

In one embodiment, simple fields can be mapped to external data source 246. By way of illustration, the simple field access method 3222 shown in FIG. 3B maps the logical field 3082 (“Patient Nickname”) to a column named “Nickname” in a temporary table 275. In this example, the temporary table 275 is populated with data from the external data source 246 using a table resolver 270 named “PropertiesPlugin” (“plugin://PropertiesPlugin”). Thus, logical field 3082 refers to a table that does not exist until the field 3082 is included in an abstract query. When this occurs, a dynamic, just in time table, is generated for this field using the table resolver “PropertiesPlugin” at query execution.

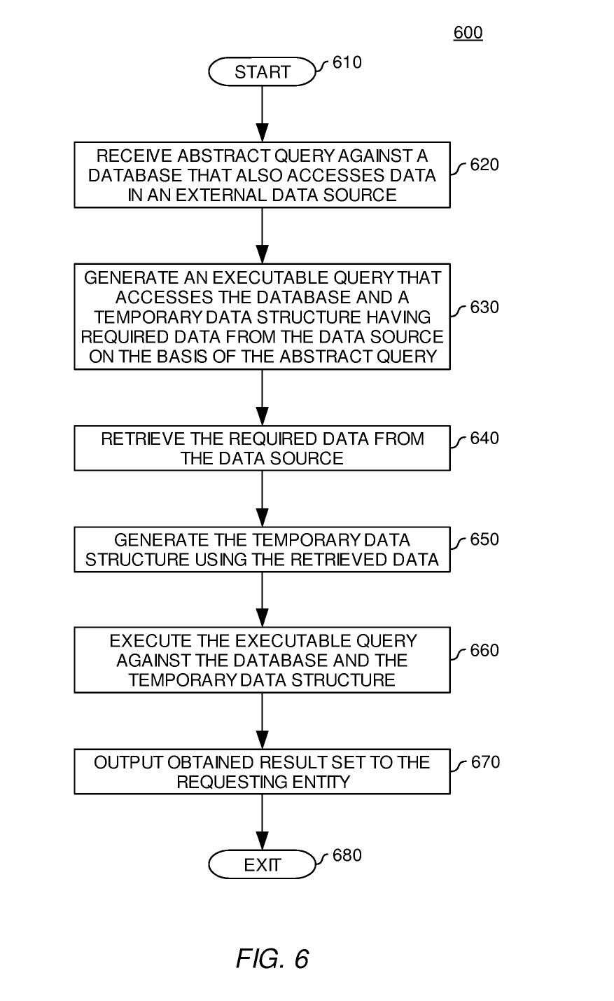

Illustratively, the designation “PropertiesPlugin” refers to a table resolver that retrieves data for the temporary table 275 directly from the external data source 246. For example, a file accessible by the query execution unit. By way of example, this table resolver type may be used to generate temporary table 275 when external data source 246 is a text file that may be accessed and parsed by the table resolver table generation method. However, as noted above, different types of data included with the external data source 246 are broadly contemplated. Accordingly, another example is illustrated by the simple field access method 322₆ shown in FIG. 3B that maps the logical field name 320₆ (“Tumor Size”) to a column named “tumorsize” in the temporary table 275 having data that is dynamically retrieved using a table resolver named “SearchEnginePlugin” (plugin://SearchEnginePlugin”). The designation “SearchEnginePlugin” refers to another resolver type that is used to determine data for the external data source 246 from another separate data source. For instance, the other separate data source can be a list of URLs returned by a search engine based on search terms (i.e., query conditions) passed to the search engine table resolver. Different exemplary resolver types are described in more detail below with reference to FIGS. 6-8.

Filtered fields identify an associated physical entity and provide filters used to define a particular subset of items within the physical representation. An example is provided in FIG. 3B in which the filtered field access method 3223 maps the logical field name 3203 (“Street”) to a physical entity in a column named “street” in the “Patientinfo” table and defines a filter for individuals in the city of “NY.” Another example of a filtered field is a New York ZIP code field that maps to the physical representation of ZIP codes and restricts the data only to those ZIP codes defined for the state of New York.

Composed access methods compute a logical field from one or more physical fields using an expression supplied as part of the access method definition. In this way, information which does not exist in the underlying physical data representation may be computed. In the example illustrated in FIG. 3B the composed field access method 322₄ maps the logical field name 320₄ “Normalized Results” to “Results/10.” Another example is a sales tax field that is composed by multiplying a sales price field by a sales tax rate.

It is contemplated that the formats for any given data type (e.g., dates, decimal numbers, etc.) of the underlying data may vary. Accordingly, in one embodiment, the field specifications 308 include a type attribute which reflects the format of the underlying data. However, in another embodiment, the data format of the field specifications 308 is different from the associated underlying physical data, in which case a conversion of the underlying physical data into the format of the logical field is required.

By way of example, the field specifications 308 of the data abstraction model 232 shown in FIG. 3B are representative of logical fields mapped to data represented in the relational data representation 2142 and the temporary table 275 shown in FIG. 3A. However, other instances of the data abstraction model 232 map logical fields to other physical representations, such as XML.

An illustrative abstract query corresponding to the abstract query 240 shown in FIG. 3B is shown in Table I below. By way of illustration, the illustrative abstract query is defined using XML. However, other languages may be used.

TABLE I
ABSTRACT QUERY EXAMPLE

| | |
|---|---|
| 001 | <?xml version=“1.0”?> |
| 002 | <!--Query string representation: (Tumor Size = ’25.0’--> |
| 003 | <QueryAbstraction> |
| 004 | <Selection> |
| 005 | <Condition internalID=“4”> |
| 006 | <Condition field=“Tumor Size” operator=“EQ” value=“25.0” |
| 007 | internalID=“1”/> |
| 008 | </Selection> |
| 009 | <Results> |
| 010 | <Field name=“Patient Nickname”/> |
| 011 | </Results> |
| 017 | </QueryAbstraction> |

Illustratively, the abstract query shown in Table I includes a selection specification (lines 004-008) containing selection criteria and a results specification (lines 009-011). In one embodiment, a selection criterion consists of a field name (for a logical field), a comparison operator (=, >, <, etc) and a value expression (what is the field being compared to). In one embodiment, a results specification is a list of abstract fields that are to be returned as a result of query execution. A results specification in the abstract query may consist of a field name and sort criteria. It should be noted that the logical fields selected for the selection criterion (line 006) and the results specification (line 010) in Table I require data that is derived from external data sources as explained in more detail with reference to Table II below. Note, in this example, no reference is made to whether data for the logical fields in this abstract query is stored in database 214 or external data source 264.

An illustrative data abstraction model (DAM) corresponding to the data abstraction model 232 shown in FIG. 3B is shown in Table II below. By way of illustration, the illustrative Data Abstraction Model is defined using XML. However, other languages may be used.

TABLE II
DATA ABSTRACTION MODEL EXAMPLE

| | |
|---|---|
| 001 | <?xml version=“1.0”?> |
| 002 | <DataAbstraction> |
| 003 | <Category name=“Patient”> |
| 004 | <Field queryable=“Yes” name=“Patient ID” displayable=“Yes”> |
| 005 | <AccessMethod> |
| 006 | <Simple attrName=“patient_ID ” entityName=“Patientinfo”></Simple> |
| 007 | </AccessMethod> |
| 008 | </Field> |
| 009 | <Field queryable=“Yes” name=“Patient Nickname” displayable=“Yes”> |
| 010 | <AccessMethod> |
| 011 | <Simple attrName =“Nickname” |
| 012 | entityName =“plugin://PropertiesPlugin”></Simple> |
| 013 | </AccessMethod> |
| 014 | </Field> |
| 015 | <Field queryable=“Yes” name=“Street” displayable=“Yes”> |
| 016 | <AccessMethod> |
| 017 | <Filter attrName =“street” entityName =“Patientinfo” |
| 018 | Filter=”Patientinfo.city=NY”> </Filter> |
| 019 | </AccessMethod> |
| 020 | </Field> |
| 021 | </Category> |
| 022 | <Category name=“Tests”> |
| 023 | <Field queryable=“Yes” name=“Normalized Results” displayable=“Yes”> |
| 024 | <AccessMethod> |
| 025 | <Composed attrName =“results” entityName =“Bloodtest” |
| 026 | Expression=”attrName /10”> </Composed> |
| 027 | </AccessMethod> |
| 028 | </Field> |
| 029 | <Field queryable=“Yes” name=“Results” displayable=“Yes”> |
| 030 | <AccessMethod> |
| 031 | <Simple attrName =“results” entityName =“Bloodtest”></Simple> |
| 032 | </AccessMethod> |
| 033 | </Field> |
| 034 | <Field queryable=“Yes” name=“Tumor Size” displayable=“Yes”> |
| 035 | <AccessMethod> |
| 036 | <Simple attrName =“tumorsize” |
| 037 | entityName =“plugin://SearchEnginePlugin”></Simple> |
| 038 | </AccessMethod> |
| 039 | </Field> |
| 040 | </Category> |
| 041 | </DataAbstraction> |

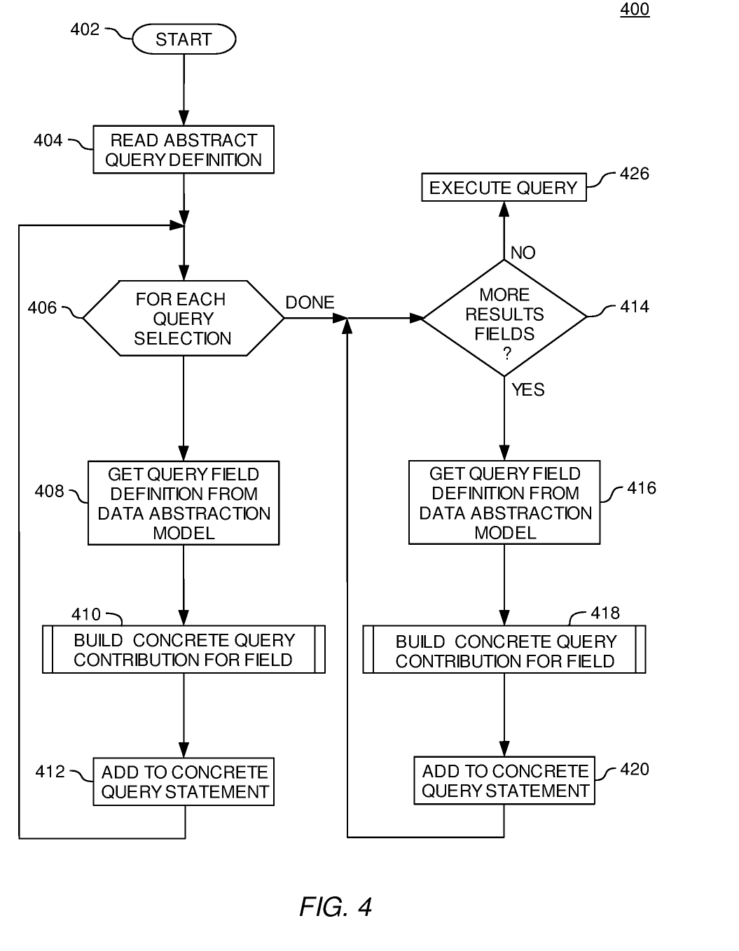

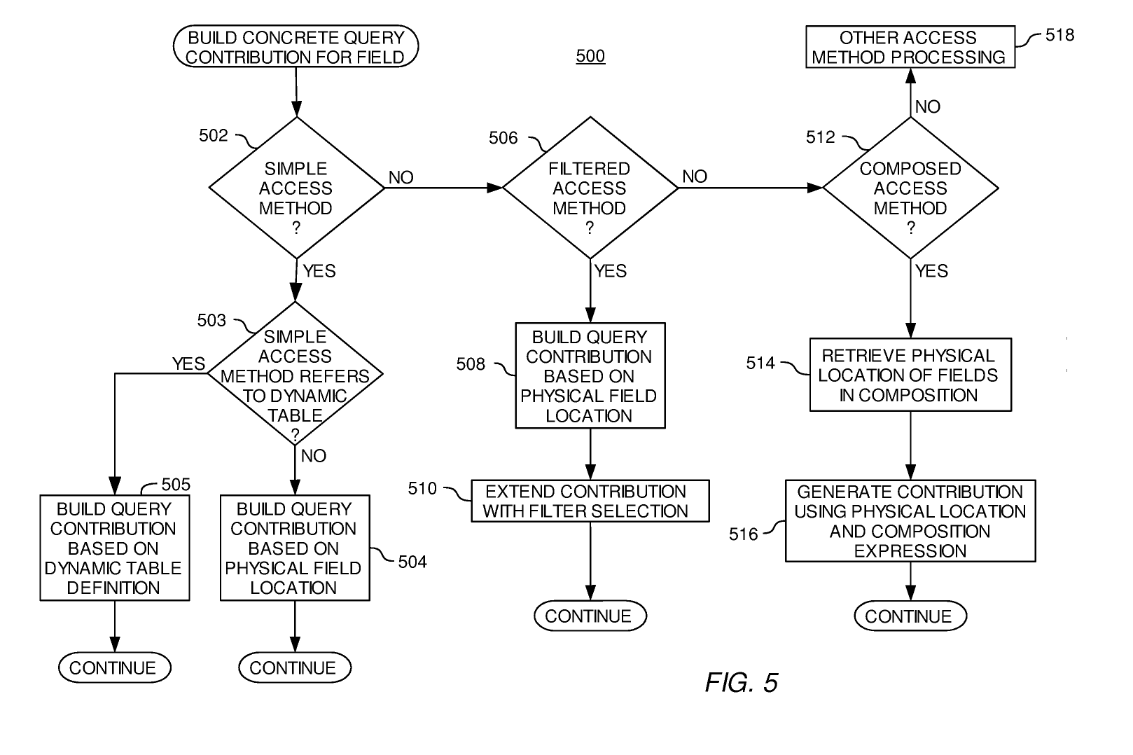

By way of example, note that lines 009-013 correspond to the field specification 308₂ of the DAM 232 shown in FIG. 3B and lines 034-039 correspond to the field specification 308₆. An executable query may be generated from the abstract query of Table I and executed against an underlying database (e.g., database 214 of FIG. 3A), including a query referencing temporary table 275. An exemplary method for generating an executable query from an abstract query is described below with reference to FIGS. 4-5.

FIG. 4 illustrates a method 400 for generating an executable query (also referred to hereinafter as “concrete” query) from an abstract query (e.g., abstract query 240 of FIG. 2) using the runtime component 234 of FIG. 2. The method 400 begins at step 402 when the runtime component 234 receives the abstract query (such as the abstract query shown in Table I). At step 404, the runtime component 234 parses the abstract query and locates selection criteria (e.g., conditions 244 of FIG. 2) and result fields (e.g., result fields 242 of FIG. 2).

At step 406, the runtime component 234 enters a loop (defined by steps 406, 408, 410 and 412) for processing each query selection criteria statement present in the abstract query, thereby building a data selection portion of a concrete query. In one embodiment, a selection criterion consists of a field name (for a logical field), a comparison operator (=, >, <, etc) and a value expression (what is the field being compared to). At step 408, the runtime component 234 uses the field name from a selection criterion of the abstract query to look up the definition of the field in the data abstraction model 232. As noted above, the field definition includes a definition of the access method used to access the data structure associated with the field. The runtime component 234 then builds (step 410) a concrete query contribution for the logical field being processed. As defined herein, a concrete query contribution is a portion of a concrete query that is used to perform data selection based on the current logical field. A concrete query is a query represented in languages like SQL and XML Query and is consistent with the data of a given physical data repository (e.g., a relational database or XML repository). Accordingly, the concrete query is used to locate and retrieve data from the physical data repository, represented by the database 214 having the temporary table 275 shown in FIG. 2. The concrete query contribution generated for the current field is then added to a concrete query statement (step 412). The method 400 then returns to step 406 to begin processing for the next field of the abstract query. Accordingly, the process entered at step 406 is iterated for each data selection field in the abstract query, contributing additional content to the executable query.

After building the data selection portion of the concrete query, the runtime component 234 identifies the information to be returned as a result of query execution. As described above, in one embodiment, the abstract query defines a list of result fields, i.e., a list of logical fields that are to be returned as a result of query execution, referred to herein as a result specification. A result specification in the abstract query may consist of a field name and sort criteria. Accordingly, the method 400 enters a loop at step 414 (defined by steps 414, 416, 418 and 420) to add result field definitions to the concrete query being generated. At step 416, the runtime component 234 looks up a result field name (from the result specification of the abstract query) in the data abstraction model 232 and then retrieves a result field definition from the data abstraction model 232 to identify the physical location of data to be returned for the current logical result field. The runtime component 234 then builds (at step 418) a concrete query contribution (of the concrete query that identifies physical location of data to be returned) for the logical result field. At step 420, the concrete query contribution is then added to the concrete query statement. Once each of the result specifications in the abstract query has been processed, processing continues at step 426, where the concrete query is executed.

FIG. 5 illustrates a method 500 for building a concrete query contribution for a logical field according to steps 410 and 418. At step 502, the query engine 254 determines whether the access method associated with the current logical field is a simple access method. If so, it is determined at step 503 whether the simple access method refers to a dynamic table. More specifically, it is determined whether the simple access method refers to an external data source (e.g., external data source 275 of FIG. 2). If so, then a dynamic table is generated prior to executing the concrete query. If so, a concrete query contribution is built (step 505) that includes a reference to a dynamic table. Prior to query execution, the query execution unit 254 instantiates the table resolver object specified by the logical field and invokes its table generation method to generate the temporary table. Note however, in one embodiment, the temporary table is not generated as part of step 505, instead, just a query contribution that includes a reference to a temporary table is generated. Processing then continues according to method 400 as described above. If, however, it is determined at step 503 that the simple access method does not refer to a dynamic table, the concrete query contribution is built (step 504) based on the physical data location information for an existing database table and processing then continues according to method 400 as described above.

If it is determined at step 502 that the access method associated with the current logical field is not a simple access method, processing continues to step 506 where the query engine 254 determines whether the access method associated with the current logical field is a filtered access method. If so, the concrete query contribution is built (step 508) based on physical data location information for a given data structure(s). At step 510, the concrete query contribution is extended with additional logic (filter selection) used to subset data associated with the given data structure(s). Processing then continues according to method 400 described above.

If the access method is not a filtered access method, processing proceeds from step 506 to step 512 where the query engine 254 determines whether the access method is a composed access method. If the access method is a composed access method, the physical data location for each sub-field reference in the composed field expression is located and retrieved at step 514. At step 516, the physical field location information of the composed field expression is substituted for the logical field references of the composed field expression, whereby the concrete query contribution is generated. Processing then continues according to method 400 described above.

If the access method is not a composed access method, processing proceeds from step 512 to step 518. Step 518 is representative of any other access method types contemplated as embodiments of the present invention. However, it should be understood that embodiments are contemplated in which less then all the available access methods are implemented. For example, in a particular embodiment only simple access methods are used. In another embodiment, only simple access methods and filtered access methods are used. Further, although described using the simple access method as an example, references to temporary tables may be and table resolver objects may be included filtered, composed or other access method types as well.

### Executing an Abstract Query

FIG. 6 illustrates an embodiment of a method 600 for executing an abstract query (e.g., abstract query 240 of FIG. 2) issued against a database (e.g., database 214 of FIG. 2) and an external data source (e.g., external data source 246 of FIG. 2). At least part of the steps of the method 600 may be performed by runtime component 234 of FIG. 2 and/or query execution unit 254. Method 600 starts at step 610.

At step 620, the abstract query issued from a requesting entity (e.g., application 220 of FIG. 2) against the database and the external data source is received. An exemplary abstract query defined in natural language, for simplicity, is shown in Table III below.

TABLE III
ABSTRACT QUERY EXAMPLE

| | |
|---|---|
| 001 | FIND |
| 002 | Patient ID, Patient Nickname |

The exemplary abstract query of Table III includes two result fields (line 002) and is configured to retrieve nicknames (“Patient Nickname” in line 002) for patients of a medical institution. Each patient is identified using a patient identifier (“Patient ID” in line 002). Note, however, for simplicity, the abstract query of Table III does not include any query conditions (e.g., conditions 244 of FIG. 2).

Assume for this example that the abstract query of Table III was created using the data abstraction model of Table II above. Accordingly, as can be seen from line 006 of Table II, the result field “Patient ID” in line 002 from the query of Table III relates to data in a “patient_ID” column of a “Patientinfo” table. In comparison, the result field “Patient Nickname” in line 002 from the query of Table III relates to data from an external data source. In one embodiment, a dynamic, just in time table is generated for this latter field using the table resolver “PropertiesPlugin” (i.e., an instance table resolver object 270 of FIG. 2). By way of example, the following steps of method 600 are explained below with reference to the abstract query of Table III and the data abstraction model of Table II.

At step 630, the abstract query of Table III is transformed into a concrete query using information from lines 004-014 of the data abstraction model illustrated in Table II. In one embodiment, the transformation is performed as described above with reference to FIGS. 4-5. An exemplary concrete SQL query that is created on the basis of the exemplary abstract query of Table III is illustrated in Table IV below. However, it should be noted that the exemplary concrete query is defined in SQL for purposes of illustration and not for limiting the invention and that all such different implementations are broadly contemplated.

TABLE IV
CONCRETE QUERY EXAMPLE

| | |
|---|---|
| 001 | SELECT DISTINCT |
| 002 | “t1”.”patient_ID” AS “Patient ID”, |
| 003 | “t2”.”Nickname” AS “Patient Nickname” |
| 004 | FROM |
| 005 | “database”.”Patientinfo” “t1” |
| 006 | LEFT OUTER JOIN SESSION.PluginTable250 “t2” |
| 007 | ON “t1”.”patient_ID” = “t2”.”patient_ID >> |

Lines 002 and 005 illustrate that the query of Table IV accesses a column “patient_ID” in a table “t1.” This table is defined by the “Patientinfo” table in the database (referred to as “database” in line 005). Lines 003 and 006 show that the query of Table IV also accesses a column named “Nickname” in a temporary table “t2” defined as “SESSION.PluginTable250.” The table name of “SESSION.PluginTable250” may be generated by the runtime component when generating the SQL query of Table IV from the abstract query of Table III. For example, a name for a temporary table may be generated as part of step 505 of the method 500 of FIG. 5. In this example, the temporary table “SESSION.PluginTable250” is joined to the “Patientinfo” table by means of a “patient_ID” column provided in both tables (lines 005-007 of Table IV).

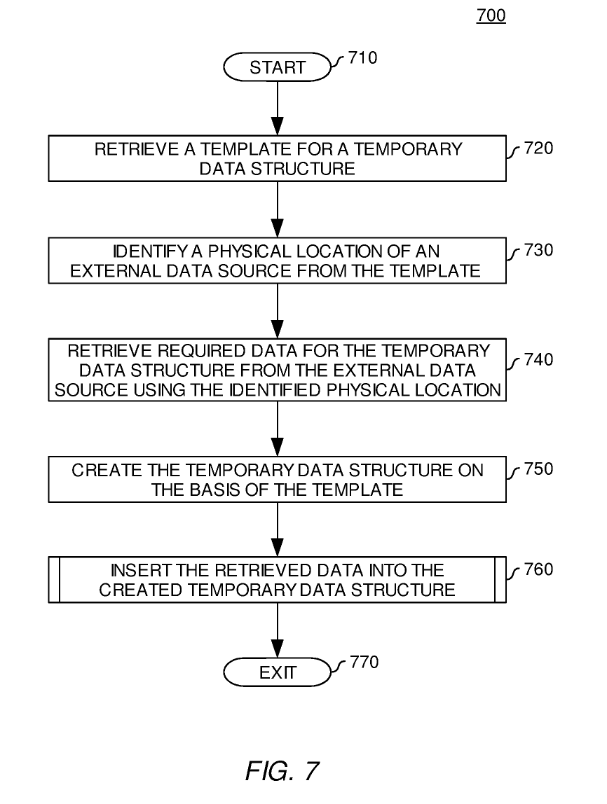

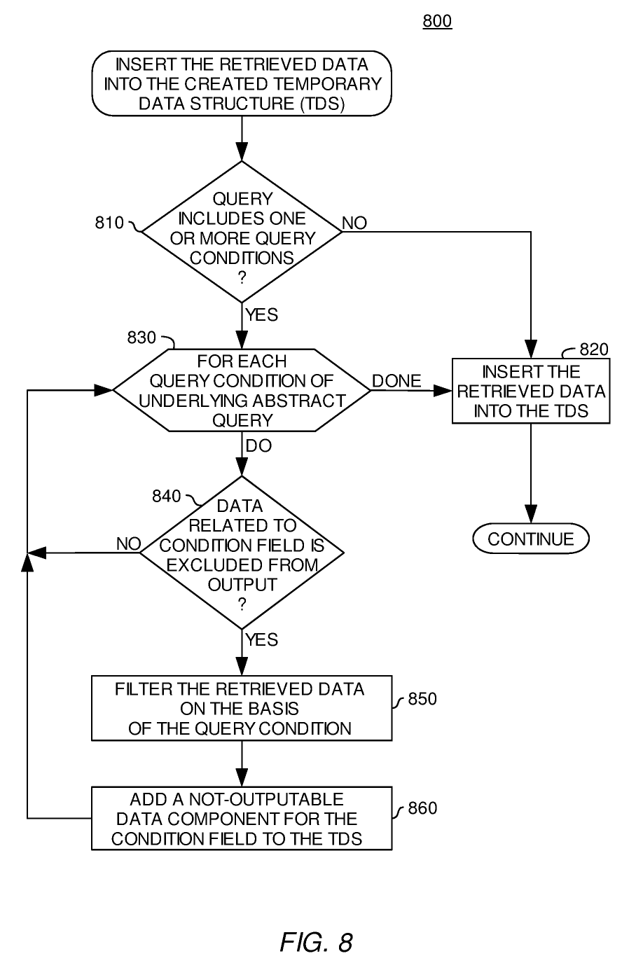

At step 640, the external data source is accessed and data for the SESSION.PluginTable250” temporary table is retrieved. At step 650, the temporary “SESSION.PluginTable250” table is created in the database and the data retrieved from the external data source is inserted therein. In one embodiment, steps 640 and 650 are performed using the table generation method provided by table resolver object 270. An exemplary method for generating the temporary “SESSION.PluginTable250” table according to steps 640 and 650 is described below with reference to FIGS. 7-8.

At step 660, the SQL query of Table IV may be executed against the database having the table “Patientinfo” and the temporary “SESSION.PluginTable250” table to obtain a corresponding result set (e.g., result set 290 of FIG. 2). However, as executing a concrete SQL query against tables in a database to obtain a corresponding result set is well-known in the art, step 660 is not described in more detail. At step 670, the obtained result set is returned to the requesting entity. Method 600 then exits at step 680.

### Generating a Temporary Data Structure in a Database

FIG. 7 illustrates a method 700 for generating a temporary data structure, according to one embodiment of the invention. The temporary data structure may be generated using data from external data source (e.g., external data source 246 of FIG. 2) and a table resolver 270 configured to retrieve data from external data source 246 and populate temporary table 275 with this data. In one embodiment, the method 700 is performed as part of steps 640 and 650 of the method 600 of FIG. 6. The steps of the method 700 may be performed by the query execution unit 254 of FIG. 2.

Method 700 begins at step 710 where a request for the temporary data structure is made. For example, the query execution unit 254 may be configured to parse a concrete query generated from an abstract query to identify any references to temporary tables. At step 720, a template for the temporary data structure is retrieved. In one embodiment, the template describes the content and structure of a temporary table generated by an instance of a table resolver object. Table V shows an exemplary template for a temporary table. The exemplary template is defined using XML. However, other appropriate markup languages may be used to define the content and structure of a temporary table generated by a table resolver object.

TABLE V
TEMPLATE EXAMPLE

| | |
|---|---|
| 001 | <Extension className=“plugin.PropertiesFileTableResolver” |
| 002 | name=“PropertiesPlugin” |
| | point=“plugin.tableResolver”> |
| 003 | <Parms> |
| 004 | <Field hidden=“Yes” name=“field_1”> |
| 005 | <Type baseType=“char”/> |
| 006 | <Description>Patient ID</Description> |
| 007 | <Value val=“data://Patient/Patient ID”/> |
| 008 | </Field> |
| 009 | <Field hidden=“Yes” name=“field_2”> |
| 010 | <Type baseType=“char”/> |
| 011 | <Description>Patient Nickname</Description> |
| 012 | <Value val=“data://Patient/Patient Nickname”/> |
| 013 | </Field> |
| 014 | <Field hidden=“Yes” name=“location”> |
| 015 | <Type baseType=“char”/> |
| 016 | <Description>Where is the external data source?</Description> |
| 017 | <Value val=“sample\\nicknames.data”/> |
| 018 | </Field> |
| 019 | </Parms> |
| 020 | <PluginDesc>Exemplary Table Resolver Instance</PluginDesc> |
| 021 | </Extension> |

The exemplary template of Table V illustrates the structure of a temporary table generated by a table resolver object. In this example, the class “plugin.PropertiesFileTableResolver” shown line 001 is instantiated to create the temporary data structure. As described above, logical field 3082 defined in lines 009-014 of Table II refers to the “PropertiesPlugin” table resolver shown in Table V. Further, when generated, the additional elements of Table V described the structure and content of the temporary table generated by the “PropertiesPlugin.” As shown, the template of Table V includes parameters (“Parms” in lines 003-019) passed to the “PropertiesPlugin” when generating the temporary data table. In this example, the required parameters include three exemplary field specifications in lines 004-008 (“field_{—}1”), 009-013 (“field_{—}2”) and 014-018 (“location”).

The field specifications for “field_{—}1” and “field_{—}2” (lines 004-013 of Table V) indicate a location of these fields in the underlying data abstraction model (lines 007 and 012). For instance, “field_{—}2” (line 009) refers to the logical field “Patient Nickname” that is included with the “Patient” category of the underlying data abstraction model (line 012 of Table V). “Field_{—}1” (line 004) refers to the logical field “Patient ID” that is used to link the temporary data structure to the underlying data abstraction model. The “location” field in lines 014-018 indicates a location of the external data source. Illustratively, assume that the external data source is a text-based file that includes the nicknames information accessed by the “Patient Nickname” logical field.

At step 730, the location of the external data source is identified. In the present example, line 017 in the exemplary template of Table V (“sample\\nicknames.data”) specifies a location in a file system where the nicknames file is located. Using this location, data used to populate the temporary data structure is retrieved from the external data source at step 740.

At step 750, the temporary data structure is created using the template retrieved at step 720 and the data retrieved from the external data source at step 740. More generally, the temporary data structure is created as a temporary table (e.g., temporary table 275 of FIG. 2). The structure of the temporary table is defined by the template of Table V. In the present example, the temporary table includes a “patient_ID” column corresponding to “field_{—}1” in lines 004-008 of Table V and a “Nickname” column corresponding to “field_{—}2” in lines 009-013 of Table V.

At step 760, the temporary table is populated with the data retrieved from the external data source “sample\\nicknames.data.” Method 700 then exits at step 770. Thus, the exemplary concrete SQL query of Table IV that references the temporary data structure (lines 003 and 006-007 of Table IV) may now be executed. By executing the query against the database and the temporary data structure, a corresponding result set (e.g., result set 290 of FIG. 2) may be obtained. The result set is obtained in a manner that is similar to execution of a query against a database that does not include a temporary data structure.

FIG. 8 illustrates one embodiment of a method 800 for populating the temporary data structure using the data retrieved from the external data source according to step 760 of the method 700 of FIG. 7. Method 800 starts at step 810 where the query execution unit determines whether the underlying abstract query includes one or more query conditions (e.g., conditions 244 of FIG. 2). If so, processing proceeds with step 830, where a loop consisting of steps 830-860 is entered for each query condition. Otherwise, processing proceeds with step 820.

At step 820, data retrieved from the external data source may be inserted into the temporary data structure. For example, the abstract query of Table III does not include any query conditions. Accordingly, the data retrieved from the external data source “sample\\nicknames.data” is inserted into the temporary table for query execution. Processing then continues at step 770 of the method 700 of FIG. 7. In other cases, however, data from the external data source may be evaluated before it is inserted into the temporary table. If data elements fail to satisfy a query condition, then such a data element is not included in the temporary table.

For purposes of illustration, assume that the abstract query illustrated in Table VI below was received from a requesting entity (e.g., application 220 of FIG. 2). For simplicity, the query shown in Table VI below is defined in natural language.

TABLE VI
ABSTRACT QUERY EXAMPLE

| | |
|---|---|
| 001 | FIND |
| 002 | Patient ID, Tumor Size, Document URL |
| 003 | WHERE |
| 004 | Document Reference = ‘intraductal carcinoma’ AND |
| 005 | Tumor Size > ’25.0’ |

As shown, the query of Table VI includes three result fields (line 002) and specifies to retrieve tumor size values (“Tumor Size” in line 002) for patients of a medical institution and hyperlinks (“Document URL” in line 002) to documents. Each patient is uniquely identified by an associated patient identifier (“Patient ID” in line 002). The exemplary abstract query of Table VI further includes two query conditions (lines 004-005). The first condition in line 004 restricts returned hyperlinks to hyperlinks that refer to documents containing the search term “intraductal carcinoma”. The second condition in line 005 restricts returned tumor size values to the value greater than “25.0”.

Assume now that the abstract query of Table VI was created using the data abstraction model of Table VII below. The illustrative Data Abstraction Model is defined using XML. However, other languages may be used.

TABLE VII
DATA ABSTRACTION MODEL EXAMPLE

| | |
|---|---|
| 001 | <?xml version=“1.0”?> |
| 002 | <DataAbstraction> |
| 003 | <Category name=“Documents” hidden=“No”> |
| 004 | <Field displayable=“No” name=“Document Reference” queryable=“Yes”> |
| 005 | <AccessMethod> |
| 006 | <Simple attrName=“DocRef” |
| 007 | entityName=“plugin://SearchEnginePlugin” /> |
| 008 | </AccessMethod> |
| 009 | </Field> |
| 010 | <Field displayable=“Yes” name=“Document URL” queryable=“No”> |
| 011 | <AccessMethod> |
| 012 | <Simple attrName=“DocumentID” |
| 013 | entityName=“plugin://SearchEnginePlugin” /> |
| 014 | </AccessMethod> |
| 015 | </Field> |
| 016 | <Field displayable=“Yes” name=“Tumor Size” queryable=“Yes”> |
| 017 | <AccessMethod> |
| 018 | <Simple attrName=“tumorsize” |
| 019 | entityName=“plugin://SearchEnginePlugin” /> |
| 020 | </AccessMethod> |
| 021 | </Field> |
| 022 | |
| 023 | <Category name=“Hidden Entity Resolver Field” hidden=“Yes”> |
| 024 | <Field displayable=“Yes” name=“Patient ID” queryable=“Yes”> |
| 025 | <AccessMethod> |
| 026 | <Simple attrName=“patient_ID” |
| 027 | entityName=“plugin://SearchEnginePlugin” /> |
| 028 | </AccessMethod> |
| 029 | </Field> |
| 030 | </Category> |
| 031 | </Category> |
| 032 | </DataAbstraction> |

As shown in Table VII, the data abstraction model includes four logical field specifications, including a “Document Reference” field (lines 004-009), a “Document URL” field (lines 010-015), a “Tumor Size” field (lines 016-021) and a “Patient ID” field (lines 024-029). Each field specification includes a “displayable” and a “queryable” attribute (lines 004, 010, 016 and 024) having either the value “Yes” or “No.” These attributes are described in more detail below with reference to step 840.

By way of example, the “Document Reference” field, the “Document URL” field and the “Tumor Size” field are included with a first category (“Documents” in lines 003-021). The “Documents” category relates to information determined using a search engine to retrieve information such as document IDs or URLs from an external data source. In one embodiment, the Omnifind® search engine available from IBM may be used. The “Patient ID” field is included with a “Hidden Entity Resolver Field” sub-category (lines 023-030) that is hidden to users (“hidden=“YES”” in line 023). The “Patient ID” field relates to information determined using the search engine (line 027) and to link the information retrieved from the external data source to the information included with the database.

Assume now that the abstract query of Table VI is transformed into the corresponding concrete SQL query of Table VIII using the data abstraction model of Table VII. In one embodiment, the transformation is performed as described above with reference to FIGS. 4-5. However, it should be noted that the concrete query is defined in SQL for purposes of illustration and not for limiting the invention; accordingly, all such different implementations are broadly contemplated.

TABLE VIII
CONCRETE QUERY EXAMPLE

| | |
|---|---|
| 001 | SELECT DISTINCT |
| 002 | “t1”.”patient_ID” AS “Patient ID”, |
| 003 | “t2”.”tumorsize” AS “Tumor Size”, |
| 004 | “t2”.”DocumentID” AS “Document URL”, |
| 005 | FROM |
| 006 | “database”.”Patientinfo” “t1” |
| 007 | LEFT OUTER JOIN SESSION.PluginTable256 “t2” |
| 008 | ON “t1”.”patient_ID” = “t2”.”patient_ID” |
| 009 | WHERE |
| 010 | “t2”.”DocRef” = ‘intraducal carcinoma’ AND |
| 011 | “t2”.”tumorsize” = ’25.0’ |

In this example, the results specification in lines 001-004 and the selection criteria in lines 009-011 correspond to the results specification in lines 001-002 and the selection criteria in lines 003-005 of Table VI, respectively. Lines 002 and 006 reference a column “patient_ID” in a table “t1” that is defined by the “Patientinfo” table in the database (referred to as “database” in line 006. Lines 003-004 and 007 reference a “tumorsize” and a “DocumentID” column in a temporary table “t2” named “SESSION.PluginTable256”. The temporary “SESSION.PluginTable256” table is populated prior to query execution with data retrieved from the external data source (in this example, search results received from a search engine). Furthermore, the temporary “SESSION.PluginTable256” table is joined to the “Patientinfo” table by means of the “patient_ID” column provided in both tables (lines 006-008 of Table VIII).

In this example, the “SESSION.PluginTable256” temporary table is created using the template shown in Table IX below. The exemplary template is defined using XML. However, other languages may be used.

TABLE IX
TEMPLATE EXAMPLE

| | |
|---|---|
| 001 | <Extension className=“plugin.SearchEngineTableResolver” |
| 002 | name=“SearchEnginePlugin” |
| | point=“plugin.tableResolver”> |
| 003 | <Parms> |
| 004 | <Field hidden=“Yes” name=“field_1”> |
| 005 | <Type baseType=“char”/> |
| 006 | <Description>Patient ID</Description> |
| 007 | <Value val=“data://Documents/Hidden Entity Resolver |
| | Field/Patient ID”/> |
| 008 | </Field> |
| 009 | <Field hidden=“Yes” name=“field_2”> |
| 010 | <Type baseType=“char”/> |
| 011 | <Description>Document Search Term</Description> |
| 012 | <Value val=“data://Documents/Document Reference”/> |
| 013 | </Field> |
| 014 | <Field hidden=“Yes” name=“field_3”> |
| 015 | <Type baseType=“char”/> |
| 016 | <Description>Document ID</Description> |
| 017 | <Value val=“data://Documents/Document URL”/> |
| 018 | </Field> |
| 019 | <Field hidden=“Yes” name=“field_4”> |
| 020 | <Type baseType=“char”/> |
| 021 | <Description>Document Reference</Description> |
| 022 | <Value val=“data://Documents/Tumor Size”/> |
| 023 | </Field> |
| 024 | <Field hidden=“Yes” name=“searchHost”> |
| 025 | <Type baseType=“char”/> |
| 026 | <Description>Location of external data source</Description> |
| 027 | <Value val=“internet-address.com”/> |
| 028 | </Field> |
| 029 | <Field hidden=“Yes” name=“SearchCollection”> |
| 030 | <Type baseType=“char”/> |
| 031 | <Description>Name of repository in external data |
| | source</Description> |
| 032 | <Value val=“col_28672”/> |
| 033 | </Field> |
| 019 | </Parms> |
| 020 | <PluginDesc>Exemplary Table Resolver Instance</PluginDesc> |
| 021 | </Extension> |

The template of Table IX illustrates the table resolver configuration for a temporary table generated from an instance of a table resolver class. In this case, an instance of the “plugin.SearchEngineTableResolver” class. This table resolver class may be instantiated to create the temporary “SESSION.PluginTable256” table. More specifically, the “Document Reference,” “Document URL,” “Tumor Size” and “Patient ID” fields of the exemplary data abstraction model of Table VII refer to columns of the temporary table that may be generated using the table resolver class of Table IX. To this end, an instance name (name=“SearchEnginePlugin”) defined in line 002 of Table IX is included with lines 007, 013, 019, 027 of Table VII.

As the exemplary template of Table IX is similar to the exemplary template of Table V above, it is not described in more detail, for brevity. However, it should be noted that the field specification in lines 024-028 of Table IX identifies the search engine used to search the external data source to retrieve data for populating the temporary “SESSION.PluginTable256” table. Assume now that the external data source includes a plurality of data repositories that can be searched using the search engine identified by the field specification in lines 024-028. Accordingly, the field specification in lines 029-033 of Table IX identifies the data repository in the external data source that needs to be searched to retrieve the data for the temporary “SESSION.PluginTable256” table

In the example relating to Tables VI-IX, it is determined at step 810 that the exemplary abstract query of Table VI includes two query conditions (lines 004-005 of Table VI). Accordingly, in this example, the method 800 proceeds with step 830, where the loop consisting of steps 830-860 is initially entered for a first query condition of the underlying abstract query. By way of example, assume now that the loop is initially entered for the query condition defined in line 004 of Table VI (“Document Reference=‘intraductal carcinoma’”).

At step 840, the logical field used as condition field to define the first query condition is identified. In this example, the logical field “Document Reference” in lines 004-009 of Table VII is identified. Then, it is determined whether the identified logical field is excluded from query output. To this end, the value of the “displayable” attribute is determined. As shown, the “displayable” attribute of the identified logical field has the value “No” (line 004 of Table VII). If it is determined at step 840 that the “displayable” attribute has the value “No”, data related to the condition field is excluded from output and processing proceeds with step 850. More generally, logical fields that include conditions passed to a table resolver may be excluded from being used as query output fields (e.g., the search terms passed to a search engine are not usually displayed as part of query results). Otherwise, processing returns to step 830, where the loop consisting of steps 830-860 is entered for a next query condition.

At step 850, the retrieved data is filtered on the basis of the query condition. Thus, in the given example only data, i.e., hyperlinks (“Document URL”) related to documents having “intraductal carcinoma” as document reference (“Document Reference=‘intraductal carcinoma’”) are selected for insertion with the temporary data structure. In other words, certain conditions may be “passed down” to the table resolve instead of being evaluated as part of the database query. When a query condition is passed down to the table resolver, it is the responsibility of the table resolver to ensure that data used to create the dynamic, just in time table satisfies the query conditions.

At step 860, a column for the condition field is included with the temporary data structure. In the given example, a “DocRef” column is created in the temporary data structure. Note that in this example, the only expression included with this column is “intraductal carcinoma.” In this case, a single value is used because the “DocRef” column is not an output column. Effectively, the “intraductal carcinoma” value for the “DocRef” column is the input to a function (in this case a search engine function configured to find documents containing the value). However, the results of the search engine are used to populate the temporary table that is accessed by the concrete query. Note that the process of generating the temporary table has already used the “intraductal carcinoma” value as a condition. That is how the search engine function retrieved the correct set documents (or links to documents) to build the temporary table in the first place. Therefore, the executable query does not need to evaluate any data relative to this the condition; instead, this condition had been performed by the table resovler object in generating the temporary table.

In the given example, the loop is entered for the query condition defined in line 005 of Table VI (“Tumor Size=‘25.0’”). As the “displayable” attribute of the logical field “Tumor Size” that defines the condition field in this query condition is “Yes” (line 016 of Table VII), processing returns from step 840 immediately back to step 830. As no other query condition is included with the underlying abstract query, processing continues with step 820.

In the given example, the filtered retrieved data is included with the temporary data structure at step 820. Processing then continues at step 770 of the method 700 of FIG. 7.

While the foregoing is directed to embodiments of the present invention, other and further embodiments of the invention may be devised without departing from the basic scope thereof, and the scope thereof is determined by the claims that follow.

What is claimed is:

1. A computer-implemented method of processing a database query, comprising:
receiving, from a requesting entity, an abstract query of data contained in a database and an external data source, the abstract query being defined using logical fields of a data abstraction model abstractly describing the data in the database and the external data source;
generating, from the abstract query, an executable query capable of being executed by a query engine, wherein the executable query includes a reference to a temporary data structure;
generating the temporary data structure using data retrieved from the external data source;
executing the executable query against the database and the temporary data structure to obtain a result set; and
returning the obtained result set to the requesting entity.

2. The method of claim 1 wherein the external data source is data stored in a text file.

3. The method of claim 1, wherein the external data source is a text-based search engine, and wherein the temporary data structure stores the results of a search engine query.

4. The method of claim 1, further comprising:
retrieving a template for the temporary data structure, the template defining a configuration of the temporary data structure and specifying a location of the external data source, and wherein the temporary data structure is generated on the basis of the retrieved template.

5. The method of claim 4, wherein generating the temporary data structure comprises:
retrieving the external data source using the location specified by the template;
creating the temporary data structure according to the configuration defined by the template; and
inserting data retrieved from the external data source into the temporary data structure.

6. The method of claim 1, wherein the database includes one or more database tables and wherein creating the temporary data structure comprises creating a temporary database table in the database containing data retrieved from the external data source.

7. The method of claim 1, wherein the abstract query comprises one or more result fields for which data is to be returned in the obtained result set, and wherein at least one of the result fields is configured to access the data of the external data source.

8. The method of claim 1, wherein the abstract query comprises one or more result fields for which data is to be returned in the obtained result set and one or more query conditions, wherein at least one of the query conditions is evaluated using data retrieved from the external data source.

9. The method of claim 8, further comprising:
determining whether data associated with the at least one of the one or more query conditions is excluded from output; and
if so, filtering data to be included with the temporary data structure on the basis of the at least one of the one or more query conditions.

10. A computer-readable medium containing a program which, when executed by a processor, performs operations for processing a database query, the operations comprising:
receiving, from a requesting entity, an abstract query of data contained in a database and an external data source, the abstract query being defined using logical fields of a data abstraction model abstractly describing the data in the database and the external data source;
generating, from the abstract query, an executable query capable of being executed by a query engine, wherein the executable query includes a reference to a temporary data structure;
generating the temporary data structure using data retrieved from the external data source; and
executing the executable query against the database and the temporary data structure to obtain a result set.

11. The method of claim 10, wherein the external data source is data stored in a text file.

12. The method of claim 10, wherein the external data source is a text-based search engine, and wherein the temporary data structure stores the results of a search engine query.

13. The computer-readable medium of claim 10, wherein the operations further comprise:
retrieving a template for the temporary data structure, the template defining a configuration of the temporary data structure and specifying a location of the external data source, and wherein the temporary data structure is generated on the basis of the retrieved template.

14. The computer-readable medium of claim 13, wherein generating the temporary data structure comprises:
retrieving the external data source using the location specified by the template;
creating the temporary data structure according to the configuration defined by the template; and
inserting data retrieved from the external data source into the temporary data structure.

15. The computer-readable medium of claim 10, wherein the database includes one or more database tables and wherein creating the temporary data structure comprises creating a temporary database table in the database containing data retrieved from the external data source.

16. The computer-readable medium of claim 10, wherein the abstract query comprises one or more result fields for which data is to be returned in the obtained result set, and wherein at least one of the result fields is configured to access the data of the external data source.

17. The computer-readable medium of claim 10, wherein the abstract query comprises one or more result fields for which data is to be returned in the obtained result set and one or more query conditions, wherein at least one of the query conditions is evaluated using data retrieved from the external data source.

18. The computer-readable medium of claim 17, wherein the operations further comprise:
determining whether data associated with the at least one of the one or more query conditions is excluded from output; and
if so, filtering data to be included with the temporary data structure on the basis of the at least one of the one or more query conditions.

19. A computing device, comprising:
a processor; and
a memory containing a program for optimizing a database query, which, when executed, performs an operation for processing a database query, comprising:
receiving, from a requesting entity, an abstract query of data contained in a database and an external data source, the abstract query being defined using logical fields of a data abstraction model abstractly describing the data in the database and the external data source;
generating, from the abstract query, an executable query capable of being executed by a query engine, wherein the executable query includes a reference to a temporary data structure;
generating the temporary data structure using data retrieved from the external data source; and
executing the executable query against the database and the temporary data structure to obtain a result set.

20. The computing device of claim 19, wherein the operations further comprise:
retrieving a template for the temporary data structure, the template defining a configuration of the temporary data structure and specifying a location of the external data source, and wherein the temporary data structure is generated on the basis of the retrieved template.

21. The computing device of claim 20, wherein generating the temporary data structure comprises:
retrieving the external data source using the location specified by the template;
creating the temporary data structure according to the configuration defined by the template; and
inserting data retrieved from the external data source into the temporary data structure.

22. The computing device of claim 19, wherein the database includes one or more database tables and wherein creating the temporary data structure comprises creating a temporary database table in the database containing data retrieved from the external data source.
